(19) United States
(12) Patent Application Publication
(10) Pub. No.: US 2025/0191294 A1
(43) Pub. Date: Jun. 12, 2025

(54) NODE VISIBILITY TRIGGERS IN EXTENDED REALITY SCENE DESCRIPTION

(71) Applicant: InterDigital CE Patent Holdings, SAS, Paris (FR)

(72) Inventors: Pierrick Jouet, Rennes (FR); Patrice Hirtzlin, Betton (FR); Sylvain Lelievre, Montgermont (FR); Loic Fontaine, noyal sur vilaine (FR)

(21) Appl. No.: 18/840,396

(22) PCT Filed: Feb. 16, 2023
(86) PCT No.: PCT/EP2023/053990

§ 371 Date: Aug. 21, 2024

(30) Foreign Application Priority Data
Feb. 23, 2022 (EP) 22305197.0

(51) Int. Cl. G06T 17/00; G06T 15/10

(52) U.S. Cl. CPC G06T 17/005; G06T 15/10; G06T 2210/61

(57) ABSTRACT

Methods, device and data stream are provided to adapt the conditions under which the visibility of an object triggers or does not trigger actions in an extended reality application. A visibility trigger is activated when the objects described in the nodes linked to the trigger are visible from the point of view of a given camera. Additional information is set at node level to adapt and specialize criteria of visibility triggers. This information relies on the nature and/or the size of the object geometry and on the nature and/or the size of the other nodes' geometry considered for the visibility estimation of the object.

### 1. TECHNICAL FIELD

The present principles generally relate to the domain of extended reality scene description and extended reality scene rendering. The present document is also understood in the context of the formatting and the playing of extended reality applications when rendered on end-user devices such as mobile devices or Head-Mounted Displays (HMD).

### 2. BACKGROUND

The present section is intended to introduce the reader to various aspects of art, which may be related to various aspects of the present principles that are described and/or claimed below. This discussion is believed to be helpful in providing the reader with background information to facilitate a better understanding of the various aspects of the present principles. Accordingly, it should be understood that these statements are to be read in this light, and not as admissions of prior art.

Extended reality (XR) is a technology enabling interactive experiences where the real-world environment and/or a video content is enhanced by virtual content, which can be defined across multiple sensory modalities, including visual, auditory, haptic, etc. During runtime of the application, the virtual content (3D content or audio/video file for example) is rendered in real-time in a way which is consistent with the user context (environment, point of view, device, etc.). Scene graphs (such as the one proposed by Khronos/glTF and its extensions defined in MPEG Scene Description format or Apple/USDZ for instance) are a possible way to represent the content to be rendered. They combine a declarative description of the scene structure linking real-environment objects and virtual objects on one hand, and binary representations of the virtual content on the other hand. Scene description frameworks ensure that the timed media and the corresponding relevant virtual content are available at any time during the rendering of the application. Scene descriptions can also carry data at scene level describing how a user can interact with the scene objects at runtime for immersive XR experiences. However, when an event is related to the visibility and/or the occlusion of real or virtual objects, there is a lack of an XR system that can take an XR scene description comprising metadata at node level describing how the visibility of the scene objects is handled at runtime and how these interactions may be updated during runtime of the XR application.

### 3. SUMMARY

The following presents a simplified summary of the present principles to provide a basic understanding of some aspects of the present principles. This summary is not an extensive overview of the present principles. It is not intended to identify key or critical elements of the present principles. The following summary merely presents some aspects of the present principles in a simplified form as a prelude to the more detailed description provided below.

The present principles relate to a method comprising obtaining a description of an extended reality scene. The description comprises a scene graph linking nodes and a trigger. The trigger is associated with a first node of the scene graph describing a camera and with a second node of the scene graph describing a first object. The second node comprises first information indicating whether the first object has to be visible by the camera to activate the trigger. The method further comprises triggering an action on nodes of the scene graph upon the first information is true.

The first information may be a percentage of the first object that has to be visible to activate the trigger or a Boolean value indicating whether the object has to be fully visible to activate the trigger. The second node may comprise second information indicating a list of second objects to be ignored (or, on the contrary, to be considered) when estimating the visibility of the first object. The second node may also comprise third information providing a simplified mesh to use instead of the mesh of the object for estimating its visibility.

The present principles also relate to an extended reality rendering device comprising a memory associated with a processor configured to implement the method above.

The present principles also relate to a data stream carrying data representative of a description of an extended reality scene. The description comprises a scene graph linking nodes and a trigger that is associated with a first node of the scene graph describing a camera and with a second node of the scene graph describing a first object. The second node comprises first information indicating whether the first object has to be visible by the camera to activate the trigger.

The first information may be a percentage of the first object that have to be visible to activate the trigger or a Boolean value indicating whether the object has to be fully visible to activate the trigger. The second node may comprise second information indicating a list of second objects to be ignored (or, at the contrary, to be considered) when estimating the visibility of the first object. The second node may also comprise third information providing a simplified mesh to use instead of the mesh of the object for estimating its visibility.

### 4. BRIEF DESCRIPTION OF DRAWINGS

The present disclosure will be better understood, and other specific features and advantages will emerge upon reading the following description, the description making reference to the annexed drawings wherein:

FIG. 1 shows an example graph of an extended reality scene description according to the present principles;

FIG. 2 shows a non-limitative example of an extended reality scene description comprising behavior data, stored at scene level, describing how a user can interact with the scene objects, described at node level, at runtime for immersive XR experiences;

FIG. 3 shows an example architecture of an XR processing engine which may be configured to implement a method according to the present principles;

FIG. 4 shows an example of an embodiment of the syntax of a data stream encoding an extended reality scene description according to the present principles;

FIGS. 5A and 5B illustrate different cases regarding the visibility of an object in an XR scene.

### 5. DETAILED DESCRIPTION OF EMBODIMENTS

The present principles will be described more fully hereinafter with reference to the accompanying figures, in which examples of the present principles are shown. The present principles may, however, be embodied in many alternate forms and should not be construed as limited to the examples set forth herein. Accordingly, while the present principles are susceptible to various modifications and alternative forms, specific examples thereof are shown by way of examples in the drawings and will herein be described in detail. It should be understood, however, that there is no intent to limit the present principles to the particular forms disclosed, but on the contrary, the disclosure is to cover all modifications, equivalents, and alternatives falling within the spirit and scope of the present principles as defined by the claims.

The terminology used herein is for the purpose of describing particular examples only and is not intended to be limiting of the present principles. As used herein, the singular forms “a”, “an” and “the” are intended to include the plural forms as well, unless the context clearly indicates otherwise. It will be further understood that the terms “comprises”, “comprising,” “includes” and/or “including” when used in this specification, specify the presence of stated features, integers, steps, operations, elements, and/or components but do not preclude the presence or addition of one or more other features, integers, steps, operations, elements, components, and/or groups thereof. Moreover, when an element is referred to as being “responsive” or “connected” to another element, it can be directly responsive or connected to the other element, or intervening elements may be present. In contrast, when an element is referred to as being “directly responsive” or “directly connected” to other element, there are no intervening elements present. As used herein the term “and/or” includes any and all combinations of one or more of the associated listed items and may be abbreviated as “/”.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element without departing from the teachings of the present principles.

Although some of the diagrams include arrows on communication paths to show a primary direction of communication, it is to be understood that communication may occur in the opposite direction to the depicted arrows.

Some examples are described with regard to block diagrams and operational flowcharts in which each block represents a circuit element, module, or portion of code which comprises one or more executable instructions for implementing the specified logical function(s). It should also be noted that in other implementations, the function(s) noted in the blocks may occur out of the order noted. For example, two blocks shown in succession may, in fact, be executed substantially concurrently or the blocks may sometimes be executed in the reverse order, depending on the functionality involved.

Reference herein to “in accordance with an example” or “in an example” means that a particular feature, structure, or characteristic described in connection with the example can be included in at least one implementation of the present principles. The appearances of the phrase in accordance with an example” or “in an example” in various places in the specification are not necessarily all referring to the same example, nor are separate or alternative examples necessarily mutually exclusive of other examples.

Reference numerals appearing in the claims are by way of illustration only and shall have no limiting effect on the scope of the claims. While not explicitly described, the present examples and variants may be employed in any combination or sub-combination.

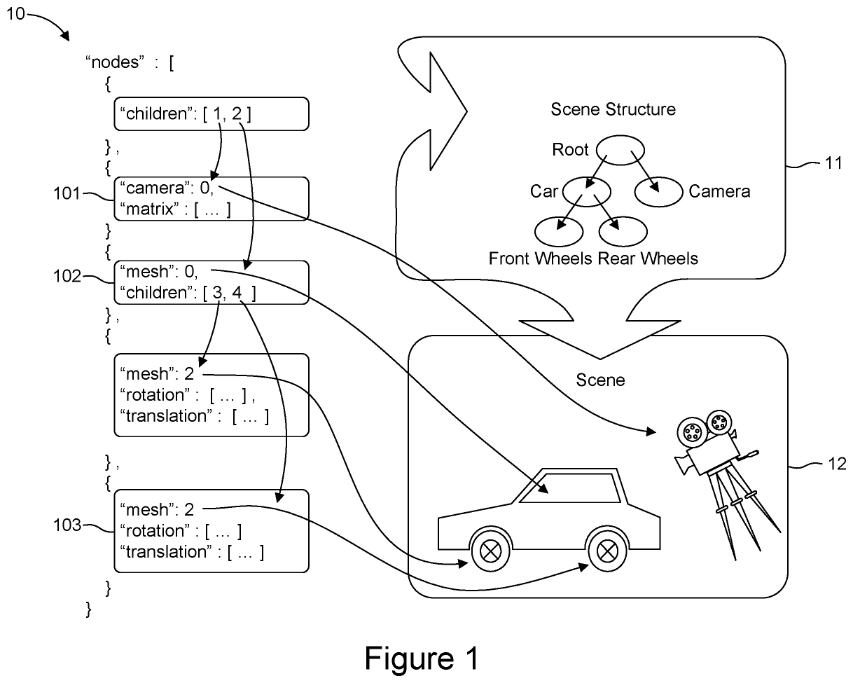

FIG. 1 shows an example graph 10 of an extended reality scene description. In this example, the scene graph may comprise a description of real objects, for example ‘plane horizontal surface’ (that can be a table or a road) and a description of virtual objects 12, for example an animation of a car. Scene description is organized as an array 10 of nodes. A node can be linked to child nodes to form a scene structure 11. A node can carry a description of a real object (e.g. a semantic description) or a description of a virtual object. In the example of FIG. 1, node 101 describes a virtual camera located in the 3D volume of the XR application. Node 102 describes a virtual car and comprises an index of a representation of the car, for example an index in an array of 3D meshes. Node 103 is a child of node 102 and comprises a description of one wheel of the car. The same way, it comprises an index to the 3D mesh of the wheel. The same 3D mesh may be used for several objects in the 3D scene as the scale, location and orientation of objects are described in the scene nodes. Scene graph 10 also comprises nodes that are a description of the spatial relations between the real objects and the virtual objects.

XR applications are various and may apply to different contexts and real or virtual environments. For example, in an industrial XR application, a virtual 3D content item (e.g. a piece A of an engine) is displayed when a reference object (piece B of an engine) is detected in the real environment by a camera rigged on a head mounted display device. The 3D content item is positioned in the real-world with a position and a scale defined relatively to the detected reference object.

For example, in an XR application for interior design, a 3D model of a piece of furniture is displayed when a given image from the catalog is detected in the input camera view. The 3D content is positioned in the real-world with a position and scale which is defined relatively to the detected reference image. In another application, an audio file might start playing when the user enters an area which is close to a church (being real or virtually rendered in the extended real environment). In another example, an ad jingle file may be played when the user sees a can of a given soda in the real environment. In an outdoor gaming application, various virtual characters may appear, depending on the semantics of the scenery which is observed by the user. For example, bird characters are suitable for trees, so if the sensors of the XR device detect real objects described by a semantic label ‘tree’, birds can be added flying around the trees. In a companion application implemented by smart glasses, a car noise may be launched in the user's headset when a car is detected within the field of view of the user camera, in order to warn him of the potential danger; Furthermore, the sound may be spatialized in order to make it arrive from the direction where the car was detected.

An XR application may also augment a video content rather than a real environment. The video is displayed on a rendering device and virtual objects described in the node tree are overlaid when timed events are detected in the video. In such a context, the node tree comprises only virtual objects descriptions.

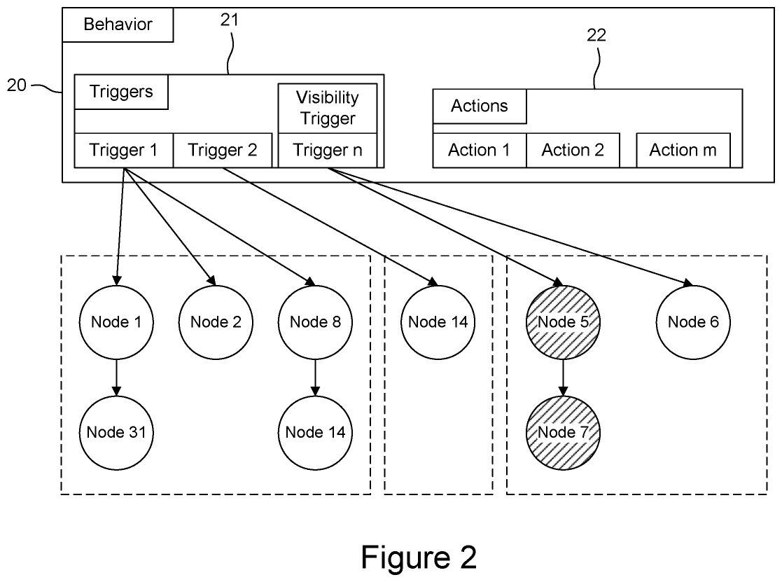

FIG. 2 shows a non-limitative example of an extended reality scene description comprising behavior data, stored at scene level, describing how a user can interact with the scene objects, described at node level, at runtime for immersive XR experiences. When the XR application is started, media content items (e.g. meshes of virtual objects visible from the camera) are loaded, rendered and buffered to be displayed when triggered. For example, when a plane surface is detected in the real environment by sensors, the application displays the buffered media content item as described in related scene nodes. The timing is managed by the application according to features detected in the real environment and to the timing of the animation. A node of a scene graph may also comprise no description and only play a role of a parent for child nodes. FIG. 2 shows relationships between behaviors that are comprised in the scene description at the scene level and nodes that are components of the scene graph. Behavior 20 are related to pre-defined virtual objects on which runtime interactivity is allowed for user specific XR experiences. Behavior 20 is also time-evolving and is updated through the scene description update mechanism.

A behavior comprises triggers 21 defining the conditions to be met for its activation. It also comprises a trigger control parameter defining logical operations between the defined triggers. It also comprises actions 22 to be processed when the triggers are activated. It also comprises an action control parameter defining the order of execution of the related actions and a priority number enabling the selection of the behavior of highest priority in the case of competition between several behaviors on the same virtual object at the same time. An optional interrupt action that specifies how to terminate this behavior when it is no longer defined in a newly received scene update may be added to the behavior. For instance, a behavior is no longer defined if a related object does not belong to the new scene or if the behavior is no longer relevant for this current media (e.g. audio or video) sequence.

Behavior 20 takes place at scene level. A trigger is linked to nodes and to the nodes' child nodes. In the example of FIG. 2, trigger 1 is linked to nodes 1, 2 and 8. As node 31 is a child of node 1, trigger 1 is linked to node 31. Trigger 1 is also linked to node 14 as a child of node 8. Trigger 2 is linked to node 14. Indeed, a same node may be linked to several triggers. Trigger n is linked to nodes 5, 6 and 7. A behavior may comprise several triggers. For instance, a first behavior may be activated by trigger 1 AND trigger 2, ‘AND’ being the trigger control parameter of the first behavior. A behavior may have several actions. For instance, the first behavior may perform Action m first and, then action 1, “first and, then” being the action control parameter of the first behavior. A second behavior may be activated by trigger n and perform action 1 first and, then action 2, for example.

The activation of a trigger is controlled by the status of the nodes the trigger is linked to. A visibility trigger at scene level is defined by two attributes: a camera node and nodes describing objects.

| | | | |
|---|---|---|---|
| cameraNode | number | M | Index, in the node array, of a camera |
| | | | node for which the visibility |
| | | | criteria are determined |
| Nodes | array | M | Indices of the nodes in the node |
| | | | array to be considered. All the |
| | | | nodes shall be visible by the camera |
| | | | to activate the trigger |

As the trigger is defined at scene level, criteria used for the activation of the trigger are the same for every node.

However, this generic mechanism has a drawback for a visibility trigger. A visibility trigger is activated when the objects described in the nodes linked to the trigger are visible from the point of view of a given camera. In the example of FIG. 2, trigger n is activated if nodes 5 and 7 are visible from a camera described by node 6. Actions associated with trigger n are then performed in the described order.

According to the present principles, additional information is set at node level to adapt and specialize criteria of visibility triggers. For example, a creator of an XR scene may require define node-specific visibility criteria depending on:
the nature and/or size of the object geometry related to that node. A full or partial visibility criterion is introduced. For example, the full or partial visibility criterion may be different for a virtual mouse, humanoid, elephant, tree or building;
the nature and/or size of the other nodes' geometry considered for the visibility computation of that node. The creator of the virtual scene may define which other nodes are relevant to estimate the visibility of an object described by a given node. For instance, a humanoid may still be considered as fully visible even if a small object (a mouse) causes an occlusion.

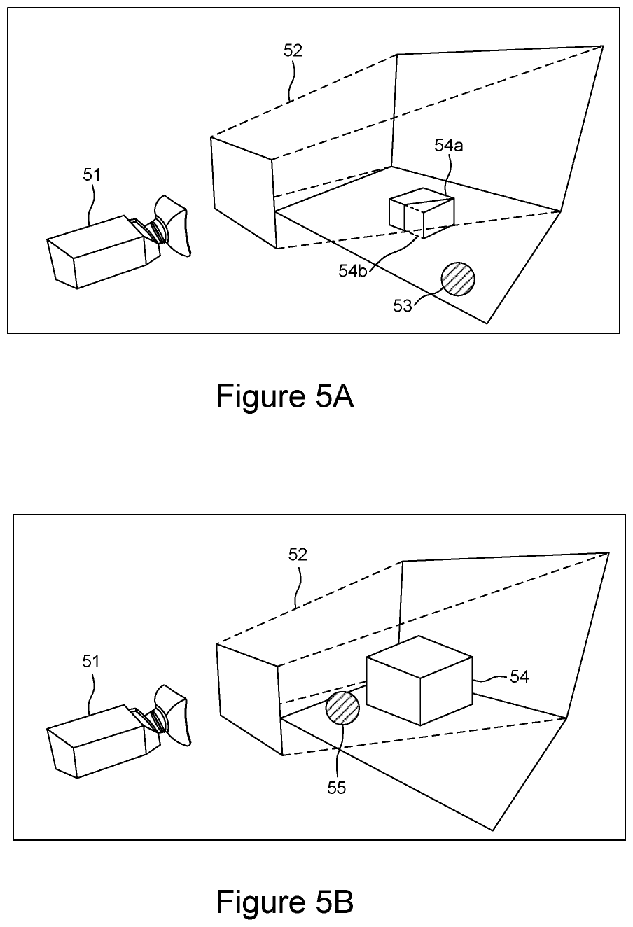

FIGS. 5A and 5B illustrate different cases regarding the visibility of an object in an XR scene. In these examples, a visibility trigger is linked to a virtual camera 51 that captures the scene visible in a frustrum 52. In FIG. 5A, sphere 53 is entirely out of the frustrum and, so, is not visible from the camera's point of view. A cube 54 is partially visible as its part 54a belongs to the space defined by the frustrum while its part 54b is out of this space. In FIG. 5B, cube 54 entirely belong to the frustrum but is only partially visible because of sphere 55 that is in front of it from the point of view of the camera.

According to the present principles, these visibility conditions are adapted by using information stored in the node describing cube 54. The notations below are given in the scope of the MPEG-I Scene Description framework using the Khronos glTF extension mechanism and show additional scene description features. It is understood that the present principles may fit to other existing or upcoming formats of XR scene description.

A scene description is augmented by specializing the criteria of visibility at the node level for a given visibility trigger. This scene description augmentation at the node level comprises a parameter indicating to what extent the visibility of the object shall be full or partial. It also comprises an array of indices of nodes whose geometries shall be ignored for the visibility trigger activation. If not indicated, the array is empty. Optionally, it may comprise a reference to a simplified mesh with respect to the object mesh, used for the visibility computation (e.g. a bounding box).

In this context, a “MPEG_Node_Visibility_Trigger” extension is defined at node level. The semantics of the MPEG_Node_Visibility_Trigger at node level is provided in the following table:

| Name | Type | Usage | Default | Description |
|---|---|---|---|---|
| visibility Full | % | M | 1 | Percentage of visible |
| | | | | part of the object to |
| | | | | activate the trigger. |
| visibilityNodesIgnored | array | D | [ ] | Set of nodes that shall |
| | | | | not be considered for |
| | | | | the visibility activation. |
| visibilityMeshIndex | number | O | | Index, in the scene |
| | | | | mesh array, of the |
| | | | | simplified mesh to |
| | | | | use to compute |
| | | | | visibility. |

Where a ‘M’ in ‘Usage’ column means that this field is mandatory in a XR scene description format according to the present principles, a ‘D’ meaning that, if not present in the scene description, a default value is used by the rendered and an ‘O’ meaning that the field is optional.

The visibilityFull field indicates a required percentage of visible part of the object to activate the trigger. By default, the object has to be fully visible. The creator of the XR scene may decide that, if only 50 percent of an object (e.g. a building) or 80 percent of an object (e.g. a table) are visible, its visibility conditions are fulfilled. For example, cube 54 of FIG. 5A could be considered as visible from camera 51 depending on the value of the visibilityFull field of its node. In a variant, the visibilityFull field is a Boolean. A true value indicating that the object has to entirely belong to the frustrum and a false value indicating that the trigger is activated if at least a part of the object is visible from the camera. In another variant, the visibilityFull field is an integer indicating the number of mesh primitives (e.g. faces, for example triangles) that have to be visible to activate the visibility trigger.

The visibility NodesIgnored field is an array of the indices of nodes describing objects that have to be ignored for the visibility conditions of the considered object. In the example of FIG. 5B, the visibility NodesIgnored field of the node of cube 54 may comprise the index of the node of sphere 55. In this example, the mesh of sphere 55 is ignored for determining the visibility of cube 54 which is considered as fully visible. By default, the visibilityNodesIgnored field is an empty array indicating that every object of the scene has to be considered for determining the visibility. In a variant, a visibilityNodesConsidered field is used instead of the visibilityNodesIgnored field. The visibilityNodesConsidered field is an array listing the indices of nodes to be considered for determining whether an object is fully visible.

During runtime, the application iterates on each behavior of the scene description. According to the present principles, when a node comprising the attributes defined according to the present principles is associated with a visibility trigger of the behavior, these attributes are used to evaluate whether the object described by the node is fully visible by the camera associated with the visibility trigger. To evaluate the visibility of an object, the application may use either rasterization, ray tracing or hybrid techniques. Rasterization and ray tracing are process used to compute the visibility problem. Rasterization technique projects object onto a plane surface determined according to parameters of the camera (from 3D representation to a 2D representation using the projection mode of the camera) as described, for example in web site “https://www.scratchapixel.com/lessons/3d-basic-rendering/rasterization-practical-implementation”. Ray tracing works by tracing a path from an imaginary eye through each pixel of a virtual screen and calculating the color of the object visible through it, as described, for instance, in web site “https://en.wikipedia.org/wiki/Ray_tracing_(graphics)”.

When a simplified mesh is provided in the node, it shall be used instead of the node mesh to compute the visibility. When a bounding box is available for the application, it is possible to take it into account instead of the node mesh to compute the visibility but if a simplified mesh is provided in the scene description. When a node according to the present principles has children, a recursive computation is performed on children's meshes. The “visibilityFull” value is propagated to child nodes for the visibility computation. If the extension is present on one node, the related parent and children of this node are not allowed to support extension.

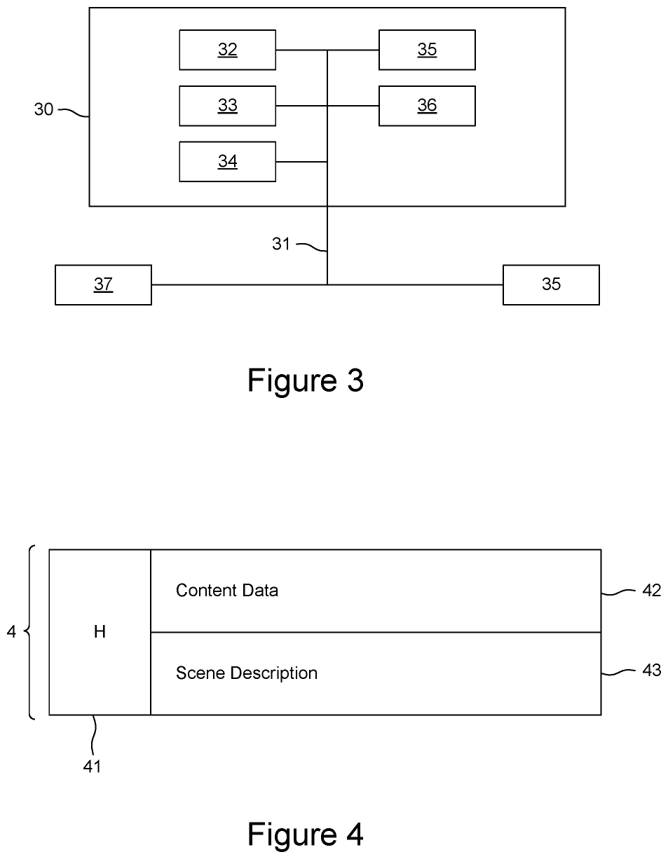

FIG. 3 shows an example architecture of an XR processing engine 30 which may be configured to implement a method described herein. A device according to the architecture of FIG. 3 is linked with other devices via their bus 31 and/or via I/O interface 36.

Device 30 comprises following elements that are linked together by a data and address bus 31:
a microprocessor 32 (or CPU), which is, for example, a DSP (or Digital Signal Processor);
a ROM (or Read Only Memory) 33;
a RAM (or Random Access Memory) 34;
a storage interface 35;
an I/O interface 36 for reception of data to transmit, from an application; and
a power supply (not represented in FIG. 3), e.g. a battery.

In accordance with an example, the power supply is external to the device. In each of mentioned memory, the word «register» used in the specification may correspond to area of small capacity (some bits) or to very large area (e.g. a whole program or large amount of received or decoded data). The ROM 33 comprises at least a program and parameters. The ROM 33 may store algorithms and instructions to perform techniques in accordance with present principles. When switched on, the CPU 32 uploads the program in the RAM and executes the corresponding instructions.

The RAM 34 comprises, in a register, the program executed by the CPU 32 and uploaded after switch-on of the device 30, input data in a register, intermediate data in different states of the method in a register, and other variables used for the execution of the method in a register.

The implementations described herein may be implemented in, for example, a method or a process, an apparatus, a computer program product, a data stream, or a signal. Even if only discussed in the context of a single form of implementation (for example, discussed only as a method or a device), the implementation of features discussed may also be implemented in other forms (for example a program). An apparatus may be implemented in, for example, appropriate hardware, software, and firmware. The methods may be implemented in, for example, an apparatus such as, for example, a processor, which refers to processing devices in general, including, for example, a computer, a microprocessor, an integrated circuit, or a programmable logic device. Processors also include communication devices, such as, for example, computers, cell phones, portable/personal digital assistants (“PDAs”), and other devices that facilitate communication of information between end-users.

Device 30 is linked, for example via bus 31 to a set of sensors 37 and to a set of rendering devices 38. Sensors 37 may be, for example, cameras, microphones, temperature sensors, Inertial Measurement Units, GPS, hygrometry sensors, IR or UV light sensors or wind sensors. Rendering devices 38 may be, for example, displays, speakers, vibrators, heat, fan, etc.

In accordance with examples, the device 30 is configured to implement a method according to the present principles, and belongs to a set comprising a mobile device, a communication device, a game device, a tablet (or tablet computer), a laptop, a still picture camera and a video camera.

FIG. 4 shows an example of an embodiment of the syntax of a data stream encoding an extended reality scene description according to the present principles. FIG. 4 shows an example structure 4 of an XR scene description. The structure consists in a container which organizes the stream in independent elements of syntax. The structure may comprise a header part 41 which is a set of data common to every syntax element of the stream. For example, the header part comprises some of metadata about syntax elements, describing the nature and the role of each of them. The structure also comprises a payload comprising an element of syntax 42 and an element of syntax 43. Syntax element 42 comprises data representative of the media content items describes in the nodes of the scene graph related to virtual elements. Images, meshes and other raw data may have been compressed according to a compression method. Element of syntax 43 is a part of the payload of the data stream and comprises data encoding the scene description as described according to the present principles.

An example of this node level visibility extension to the MPEG-I scene description is provided below. Fields introduced by the present principles are in bold.

#

```
{
  ″extensionsUsed″ [
    ″ MPEG_scene_interactivity ″,
    ″ MPEG_Node_Visibility_Trigger ″
  ],
  ″scene″: 0,
  ″scenes″: [
    {
      ″extensions″: {
      ″ MPEG_scene_interactivity ″: {
      “triggers:” [
          {
          ″type″: VISIBILITY,
          ″ nodes″:[0,1]
          },
      ],
      “actions:” [
        {
          ″ type″: ACTIVATE,
          ″ activationStatus″ : ENABLED
          ″ nodes ″[ 0]
        },
        {
          ″ type″: PLACE_AT,
                ″ placeDescription″: “/user/hand/left/pose”
          ″ nodes″:[1]
        }
      ],
      “behaviors:” [
        {
        “triggers”:[0],
        “actions”:[1],
        “triggersControl“:LOGICAL_AND
        “actionsControl”:SEQUENTIAL,
        “interruptAction“:3,
        “priority”: 1
        },
      ]
    },
      ″name″: ″Scene″,
      ″nodes″: [
        0
      ]
  ],
  ″nodes″: [
    {
      ″extensions″: {
        ″ MPEG_{—}Node_{—}Visibility_{—}Trigger ″: {
          “visibilityFull”: True
      }
        ″name″: ″Node0″,
        ″mesh″: 0,
        “matrix″: [
              1,
              0,
              0,
              0,
              0,
              2.2204460492503131e−16,
              −1,
              0,
              0,
              1,
              2.2204460492503131e−16,
              0,
              −16.122444152832031,
              −5.4808502197265625,
              44.829315185546875,
              1
            ]
    },
    {
      ″extensions″: {
        ″ MPEG_{—}Node_{—}Visibility_{—}Trigger ″: {
          “visibilityFull”: False,
          “visibilityNodesNotConsidered”: [4,6],
          “visibilityMeshIndex”: [2]
      }
        ″name″: ″Node1″,
        ″mesh″: 1,
        “matrix″: [
              1,
              0,
              0,
              0,
              0,
              0,
              −1,
              0,
              0,
              1,
              0,
              0,
              −18.12,
              −6.48,
              42.8,
              1
            ]
    },
    ...
  ]
}
```

1. A method comprising:
obtaining a description of an extended reality scene, the description comprising:
a scene graph and a set of behavior information associating one or triggers with one or more actions on nodes of the scene graph; and
one or more triggers, wherein a trigger is associated with:
a first node of the scene graph describing a camera; and
a second node of the scene graph describing a first object and comprising first information indicating at what extent the first object has to be visible by the camera to activate the trigger; and
applying the one or more actions associated with the one or more triggers in the set of behavior information when conditions of the first information are fulfilled.

2. The method of claim 1, wherein the first information is a percentage value indicating a part of the first object to be visible from the camera to activate the trigger, the trigger being activated on condition that at least the part of the first object is visible by the camera.

3. The method of claim 1, wherein the first information is a Boolean value, a true value indicating that the trigger is activated only on condition that the first object is fully visible by the camera, and a false value indicating that the trigger is activated on condition that at least a part of the first object is visible by the camera.

4. The method of claim 1, wherein the first information is a number value indicating how many faces of a mesh representative of a geometry of the first object has to be visible to activate the trigger.

5. The method of claim 1, wherein the second node comprises second information indicating a list of third nodes describing second objects to be ignored to evaluate whether the first object is fully visible.

6. The method of claim 1, wherein the second node comprises second information indicating a list of third nodes describing second objects to be considered to evaluate whether the first object is fully visible.

7. The method of claim 1, wherein the second node comprises third information indicating a mesh to use to evaluate whether the first object is fully visible.

8. A device comprising a memory associated with a processor configured for:
obtaining a description of an extended reality scene, the description comprising:
a scene graph and a set of behavior information associating one or triggers with one or more actions on nodes of the scene graph; and
one or more triggers wherein a trigger is associated with:
a first node of the scene graph describing a camera; and
a second node of the scene graph describing a first object and comprising a first information indicating at what extent the first object has to be visible by the camera to activate the trigger; and
applying the one or more actions associated with the one or more triggers in the set of behavior information of the scene graph when conditions of the first information are fulfilled.

9. The device of claim 8, wherein the first information is a percentage value indicating a part of the first object to be visible from the camera to activate the trigger, the trigger being activated on condition that at least the part of the first object is visible by the camera.

10. The device of claim 8, wherein the first information is a Boolean value, a true value indicating that the trigger is activated only on condition that the first object is fully visible by the camera, and a false value indicating that the trigger is activated on condition that at least a part of the first object is visible by the camera.

11. The device of claim 8, wherein the first information is a number value indicating how many faces of a mesh representative of a geometry of the first object has to be visible to activate the trigger.

12. The device of claim 8, wherein the second node comprises a second information indicating a list of third nodes describing second objects to be ignored to evaluate whether the first object is fully visible.

13. The device of claim 8, wherein the second node comprises a second information indicating a list of third nodes describing second objects to be considered to evaluate whether the first object is fully visible.

14. The device of claim 8, wherein the second node comprises a third information indicating a mesh to use to evaluate whether the first object is fully visible.

15. A non-transitory computer-readable medium carrying data representative of a description of an extended reality scene, the description comprising:
a scene graph and a set of behavior information associating one or triggers with one or more actions on nodes of the scene graph; and
one or more triggers, wherein a trigger is associated with:
a first node of the scene graph describing a camera; and
a second node of the scene graph describing a first object and comprising first information indicating at what extent the first object has to be fully visible by the camera to activate the trigger.

16. The non-transitory computer-readable medium of claim 15, wherein the first information is a percentage value indicating a part of the first object to be visible from the camera to activate the trigger.

17. The non-transitory computer-readable medium of claim 15, wherein the first information is a Boolean value, a true value indicating that the trigger is activated only on condition that the first object is fully visible by the camera, and a false value indicating that the trigger is activated on condition that at least a part of the first object is visible by the camera.

18. The non-transitory computer-readable medium of claim 15, wherein the first information is a number value indicating how many faces of a mesh representative of a geometry of the first object has to be visible to activate the trigger.

19. The non-transitory computer-readable medium of claim 15, wherein the second node comprises a second information indicating a list of third nodes describing second objects to be ignored to evaluate whether the first object is fully visible.

20. The non-transitory computer-readable medium of claim 15, wherein the second node comprises a second information indicating a list of third nodes describing second objects to be considered to evaluate whether the first object is fully visible.

21. The non-transitory computer-readable medium of claim 15, wherein the second node comprises a third information indicating a mesh to use to evaluate whether the first object is fully visible.
